(19) United States
(12) Patent Application Publication
(10) Pub. No.: US 2024/0094689 A1
(43) Pub. Date: Mar. 21, 2024

(54) ELECTRICAL ENERGY STORAGE SYSTEM, METHOD FOR STORING AND RETRIEVING ELECTRICAL ENERGY, AND COMPUTER PROGRAMME

(71) Applicant: Hypnetic GmbH, Hannover (DE)

(72) Inventors: Alexander Börgel, Hannover (DE); Niko Dalke, Hannover (DE); Eugen Zukin, Hannover (DE)

(73) Assignee: Hypnetic GmbH, Hannover (DE)

(21) Appl. No.: 18/275,115

(22) PCT Filed: Jan. 27, 2022
(86) PCT No.: PCT/EP2022/051896

§ 371 Date: Jul. 31, 2023

(30) Foreign Application Priority Data
Feb. 1, 2021 (DE) 10 2021 102 231.2

(51) Int. Cl. G05B 15/02; H02J 15/00

(52) U.S. Cl. CPC G05B 15/02; H02J 15/003; H02J 15/006

(57) ABSTRACT

The invention relates to an electrical energy storage system for injecting and withdrawing electrical energy, comprising at least the following components:
a) an electrical connection unit for connecting the energy storage system to an electrical energy supply grid,
b) a first energy converter that is electrically connected to the electrical connection unit and is configured to convert electrical energy supplied via the energy supply grid into hydraulic energy that is provided via a hydraulic medium located in the energy storage system,
c) a second energy converter that is hydraulically connected to the first energy converter and is configured to convert the hydraulic energy provided by the first energy converter into gas pressure energy that is provided via a pressurized gas located in the energy storage system,
d) a pressurized gas storage unit that is connected to the second energy converter via a pressurized gas connection and is configured to store the gas pressure energy provided by the second energy converter in the form of compressed pressurized gas.

The invention also relates to a method for injecting and withdrawing electrical energy by way of such energy storage system.

### FIELD OF THE INVENTION

The invention relates to an electrical energy storage system for injecting and withdrawing electrical energy, where the electrical energy storage system includes:
a) an electrical connection unit for connecting the energy storage system to an electrical energy supply grid,
b) a first energy converter that is electrically connected to the electrical connection unit and is configured to convert electrical energy supplied via the energy supply grid into hydraulic energy that is provided via a hydraulic medium located in the energy storage system,
c) a second energy converter that is hydraulically connected to the first energy converter and is configured to convert the hydraulic energy provided by the first energy converter into gas pressure energy that is provided via a pressurized gas located in the energy storage system,
d) a pressurized gas storage unit that is connected to the second energy converter via a pressurized gas connection and is configured to store the gas pressure energy provided by the second energy converter in the form of compressed pressurized gas.

Such an energy storage system may also be referred to as a hydropneumatic energy storage system. The invention also relates to a method for injecting and withdrawing electrical energy by way of an energy storage system of the type mentioned above and to a computer program for carrying out the method.

### BACKGROUND OF THE INVENTION

The energy revolution is playing a central role in climate protection goals. Energy-related problems are the unpredictability of the energy offered by solar power and wind power and peak loads, and unused industrial waste heat. The former leads to planning uncertainties, grid fluctuations and to monetary and energy losses in terms of energy procurement for a company. Peak loads cause high costs and likewise load local power grids. The around 226 terawatt-hours (TWh) of industrial heat and the around 5.5 TWh of wind energy that remain unused every year in Germany are a considerable factor for inefficiency and at the same time for potential savings. The expansion of solar power and wind power with the simultaneous dismantling of baseload nuclear and coal-fired power plants is leading overall to a growing energy compensation demand for grid stability.

Energy storage units are able in principle to meet energy compensation demands. The majority of energy storage is taken on nowadays by pumped-storage power plants and batteries. The expansion of pumped-storage power plants in Germany has been stagnating since 2015. Among batteries, the lithium battery is prevalent, and is becoming ever more so. Its major disadvantage, which constitutes a problem that is becoming greater as use increases, is the enormous use of critical resources for large-scale injection. Due to its comparatively poor robustness (cycle stability), its capacity and performance degradation and sensitivity to deep discharging, its service life is limited to five, and at most 15 years.

Conventional compressed-air energy storage units, also called CAES power plants, achieve low efficiency and cannot be used in a decentralized manner because they rely on underground caves. The common feature of these conventional CAES power plants is that nitrogen or compressed air is compressed directly by gas compressors in the injection process before it is relaxed via gas turbines in the withdrawal process so as to output power. The resulting compression heat in the gas compressor results in relatively low efficiency, and cooling systems become necessary. The higher the gas pressure (and accordingly the energy density) is supposed to be, the more compressor stages are required, the lower the efficiency and the larger the cooling circuit has to be designed.

The feasibility study regarding decentralized hydraulic pressurized gas storage units, authors: Hermann Edtmayer, Mario Habring, Markus Rabensteiner, Thomas Nacht, Manfred Tragner, 4ward Energy Research GmbH, drafted on 27 Feb. 2017, describes further approaches for compressed air energy storage units that are able to be achieved with less outlay than CAES power plants.

### SUMMARY OF THE INVENTION

The invention is directed to more efficient and durable options for storing electrical energy by way of pressurized gas.

In accordance with the invention, an electrical energy storage system as described herein, includes one or more of the following features e), f) and g):
e) at least part of the second energy converter and/or of the pressurized gas storage unit has a phase change storage medium in which compression heat that arises when the pressurized gas is compressed is able to be stored,
f) the second energy converter has at least one piston chamber in which a separator piston is mounted so as to be able to move, wherein the pressurized gas is separated from the hydraulic medium by the separator piston, wherein the separator piston has a base material and a thermal insulation material that has lower thermal conductivity than the base material, wherein a thermal insulation layer is formed between the pressurized gas and the hydraulic medium by the thermal insulation material,
g) the second energy converter has at least one hydraulic cylinder and a pneumatic cylinder that is separate from the hydraulic cylinder, mechanically coupled to the hydraulic cylinder and is able to be thermally decoupled from the hydraulic cylinder.

The energy storage system thus first has features a), b), c) and d). The electrical connection unit may for example have components for performing voltage conversion, current conversion and/or frequency conversion on the electrical energy provided by the energy supply grid. By way of example, the connection unit may have a transformer and a frequency converter connected downstream of the transformer.

The electrical energy supply grid may be a public district supply grid, or a private energy supply grid, for example an internal energy supply grid in an industrial plant, or a local energy supply grid of an energy supply installation, for example of a wind farm or of a solar energy farm. The same electrical energy supply grid that is used for injection may be used for withdrawing electrical energy from the energy storage system, or a different energy supply grid or other electrical consumers may be used.

The first energy converter may for example be implemented such that, with regard to the electrical side, it has an electric machine by way of which the electrical energy is used to drive a hydraulic conveyor device using which the hydraulic medium is able to be conveyed. The electric machine may be designed for example as an electric motor, for example as a synchronous machine or reluctance motor. The hydraulic conveyor device may be designed for example as a hydraulic pump. For example, it is advantageous for the hydraulic conveyor device to be designed as an axial piston machine, which leads to high efficiency with regard to the conversion of mechanical energy into hydraulic energy. An axial piston machine additionally also permits the reverse conversion with high efficiency, that is to say the conversion of hydraulic energy into mechanical energy. The first energy converter may also have multiple electric machines that act in parallel and/or multiple hydraulic conveyor devices that act in parallel.

The second energy converter may be designed for example as a cylinder with a piston able to move therein or an arrangement of multiple cylinders each having a piston able to move therein. The second energy converter may also have multiple such arrangements, including in mixed form, connected in parallel.

The pressurized gas storage unit may be formed by one or more gas-tight containers connected in parallel.

Electrical energy is withdrawn from the energy storage system by converting the gas pressure energy stored in the pressurized gas storage unit back into electrical energy by way of a decompression process. The withdrawal, similarly to the injection, may take place in two stages, that is to say via the interposed hydraulic medium, or else alternatively directly using an energy converter that is designed to convert gas pressure energy into electrical energy. Such an energy converter may be designed for example as a gas turbine by way of which an electrical generator is driven.

If the withdrawal takes place in the same way as the injection, that is to say using interposed hydraulic medium, then the second energy converter may be used for this if it is able to be operated bidirectionally. The first energy converter may likewise be used here if it is able to be operated bidirectionally. As an alternative, a further second energy converter may be used to convert the gas pressure energy into hydraulic energy during the withdrawal. As an alternative to the first energy converter, a further first energy converter may be used to convert the hydraulic energy into electrical energy during the withdrawal. By way of example, a Pelton turbine with a connected electrical generator may be used for the withdrawal.

The energy storage system may be designed as an open or closed system. A closed system is characterized in that there is no connection of the pressurized gas circuit to the ambient atmosphere. In this case, it is advantageous to use a pressurized gas other than air, for example nitrogen. Of course, it is also possible to operate a closed system with air as pressurized gas. In an open system, there is a connection of the pressurized gas circuit to the ambient atmosphere that is able to be closed off by at least one valve. Using this connection, air is able to be introduced into the energy storage system from the atmosphere or output back into the atmosphere as required.

Advantageously, according to feature e), at least part of the second energy converter and/or of the pressurized gas storage unit may have a phase change storage medium in which compression heat is able to be stored. Such a phase change storage medium is able to store large amounts of heat and output same again when required. The materials required for this are able to be provided easily and inexpensively, with for example paraffin, water or salt hydrates being able to be used as phase change storage medium. Using such a phase change storage medium means that the energy storage system is able to be operated very efficiently and without the temperature problems that occur in known pressurized gas power plants. An additional cooling medium, such as for example a cooling water circuit or another heat exchanger, in the region of the second energy converter and/or of the pressurized gas storage unit may in this case be dispensed with. The energy storage system may thereby be designed in a particularly simple manner.

The phase change storage medium, also called PCM (phase change material), has the property whereby the compression heat first brings about a temperature increase of the PCM up to the melting point of the PCM. Compression heat that accrues beyond this leads to liquefaction of the PCM and no longer directly to a temperature increase of the components (the temperature increase actually levels off depending on the heat exchange dynamics (heat transfer surface)). This process is reversible. The heat stored in the PCM may be output again, with the PCM solidifying again below the melting point.

By virtue of the thermal insulation layer, as indicated in feature f), the separator piston able to move in the piston chamber is able to be designed with significantly better thermal insulation, meaning that the undesired transfer of heat between the pressurized gas and the hydraulic medium is able to be considerably reduced in comparison with a design of the separator piston without a thermal insulation layer. The separator piston may be manufactured for example from a base material such as steel, which naturally has a relatively high thermal conductivity. By virtue of the thermal insulation layer, which may be arranged on one or both surface sides of the separator piston, for example in the form of a plastic layer, this undesired transfer of heat is able to be considerably reduced.

The design of the second energy converter with hydraulic and pneumatic cylinders that are separate from one another, as indicated in feature g), means that it is likewise possible to achieve good thermal decoupling between the pressurized gas and the hydraulic medium. To this end, the pneumatic cylinder may for example be thermally decoupled from the hydraulic cylinder, for example by a thermal insulation layer arranged between them. In this design, each of the cylinders, that is to say the hydraulic cylinder and the pneumatic cylinder associated with the hydraulic cylinder, may have its own piston chamber with a piston arranged so as to be able to move therein.

This design also ensures that oxygen present in the external air, which oxygen is extremely reactive as a result of the compression, is in no way able to come into contact with the hydraulic medium, for example oil. This is an important safety aspect. Oil may react explosively with oxygen and high pressure and heat. If normal piston accumulators were to be used in this concept, oil leakages in the piston seal in connection with oxygen in the air could become dangerous. Beyond this safety aspect, the oil also ages faster in the presence of oxygen, which results in a higher maintenance intensity and/or a shorter service life.

Undesirable contamination effects of the pressurized gas caused by any traces of hydraulic medium that may have penetrated through are additionally minimized. The hydraulic cylinder and the pneumatic cylinder may for example each have a piston rod by way of which they are mechanically coupled to one another. The piston rods may be mechanically coupled by way of a material having lower thermal conductivity or an arrangement having lower thermal conductivity.

The hydraulic cylinder may be coupled directly to the pneumatic cylinder associated therewith, for example by virtue of the cylinders being flanged directly to one another or connected to one another in some other way. The hydraulic cylinder may also be arranged at a distance from the pneumatic cylinder associated therewith, that is to say not be structurally attached directly by way of its housing to the housing of the pneumatic cylinder.

According to one advantageous embodiment of the invention, provision is made for the hydraulic cylinder to have a piston chamber that is divided into two mutually separate compartments by a piston mounted so as to be able to move in the piston chamber, wherein one compartment is able to be filled with the hydraulic medium and the second compartment is able to be filled with an inert gas, wherein the energy storage system may have a storage reservoir for inert gas that is connected or is able to be connected to the second compartment. It is thereby possible to provide an additional separation between the hydraulic medium in the hydraulic cylinder and the pressurized gas in the pneumatic cylinder in order, for safety reasons, to avoid reactive states that may occur in the case of oxygen components in the pressurized gas. This is particularly advantageous in the case of direct mechanical coupling of the housing of the pneumatic cylinder to the housing of the hydraulic cylinder.

According to one advantageous embodiment of the invention, provision is made for the pneumatic cylinder to have a piston chamber that is divided into two mutually separate compartments by a piston mounted so as to be able to move in the piston chamber, wherein one compartment is able to be filled with the pressurized gas and the second compartment is able to be filled with a non-combustible fluid, wherein the energy storage system may have a storage reservoir containing the non-combustible fluid that is connected or is able to be connected to the second compartment of the pneumatic cylinder. It is thereby possible to provide an additional separation between the hydraulic medium in the hydraulic cylinder and the pressurized gas in the pneumatic cylinder in order, for safety reasons, to avoid reactive states that may occur in the case of oxygen components in the pressurized gas. This is particularly advantageous in the case of direct mechanical coupling of the housing of the pneumatic cylinder to the housing of the hydraulic cylinder. This also makes it possible to avoid an explosive mixture.

This in particular makes it possible to satisfy pressurized device guideline requirements reliably and with low outlay. The inert gas may for example be nitrogen. The non-combustible fluid may be water. In this combination, for example, oil may be used as hydraulic medium and air from the environment may be used as pressurized gas.

Such feeding of the respective second compartment of the hydraulic cylinder and/or of the pneumatic cylinder additionally makes it possible to minimize wear of the cylinder. Since a combination of a gas and a fluid is present in the hydraulic cylinder and in the pneumatic cylinder, respectively, the piston seals are preserved and dry operation is avoided. The piston seals may additionally be stabilized by the counterpressure, as a result of which, overall, less hydraulic fluid from the hydraulic cylinder and pressurized gas from the pneumatic cylinder reach the respective other piston side in an undesirable manner. This arrangement thus increases the efficiency and the durability of the energy storage unit.

The second energy converter is able to bring about the forced return of the pistons by way of cyclically conveying inert gases and non-combustible fluids back and forth. The second energy converter makes it possible to avoid an accumulation of combustible gas mixtures, for example oxygen in the air in contact with hydraulic fluids, with the aid of a compartment filled with an inert gas and/or with the aid of a compartment filled with a non-combustible fluid within the piston accumulator or double piston accumulator.

According to one advantageous embodiment of the invention, the effective cross-sectional area of the piston of the hydraulic cylinder is greater or less than the effective cross-sectional area of the pneumatic cylinder associated with the hydraulic cylinder. A hydraulic-pneumatic pressure ratio may thereby be achieved with low outlay.

According to one advantageous embodiment of the invention, provision is made for the pressurized gas to be compressed, when electrical energy is injected into the energy storage system, by way of a multi-stage process, wherein at least the first stage of the compression is performed by a compression machine connected or able to be connected to the pressurized gas circuit of the second energy converter. The compression machine may be designed for example as a compressor or as a reverse-operated gas or compressed air turbine. The compression machine may be present as an additional component of the energy storage system. This has the advantage that whenever there is a need to feed additional pressurized gas externally into the pressurized gas circuit of the energy storage system, this pressurized gas is already able to be injected in pre-compressed form. The efficiency of the energy storage system is thereby able to be further increased. By way of example, air may be taken in from the atmosphere by the compressor and fed into the pressurized gas circuit of the second energy converter as pre-compressed air. The pressurized gas may for example already be pre-compressed to a pressure in the range of 40 to 80 bar by the compression machine when it is supplied to the second energy converter.

According to one advantageous embodiment of the invention, provision is made for the pressurized gas to be expanded, when electrical energy is withdrawn from the energy storage system, by way of a multi-stage process, wherein at least the last stage of the expansion is performed by an expansion machine connected or able to be connected to the pressurized gas circuit of the second energy converter. The expansion machine may be designed for example as a gas or compressed air turbine or as a reverse-operated compressor. The efficiency of the energy storage system is thereby also able to be further increased.

According to one advantageous embodiment of the invention, provision is made for the pressurized gas storage unit to have a heat exchanger by way of which waste heat supplied externally to the heat exchanger or the compression heat injected during loading is able to be supplied to the compressed pressurized gas. Further energy is able to be supplied to the pressurized gas by the heat exchanger of the pressurized gas storage unit, with it advantageously being possible to use energy that arises as a waste product, as it were, for example in industrial manufacturing processes (so-called waste heat). It is additionally also possible to use other energy sources that provide heat, for example solar panels, which are likewise connected to the heat exchanger. The efficiency of the energy storage system is thereby able to be further increased.

According to one advantageous embodiment of the invention, provision is made for at least part of the phase change storage medium to be arranged on an outside of at least part of the second energy converter and/or of the pressurized gas storage unit, on which cooling fins and/or other cooling structures are arranged. The transfer of heat from the pressurized gas to which the compression heat is applied to the phase change storage medium may thereby be optimized.

According to one advantageous embodiment of the invention, provision is made for the cooling fins and/or other cooling structures to be covered with a thermally insulating material layer and for the phase change storage medium to be arranged in the cavities remaining between the thermally insulating material layer, the cooling fins and/or other cooling structures and the outside of at least part of the second energy converter and/or of the pressurized gas storage unit. The phase change storage medium is thereby able to be separated from the atmosphere at least partially by the thermally insulating material layer. The thermally insulating material layer may for example be a plastic layer, for example a plastic film. This enables simple and inexpensive manufacture of the corresponding parts of the second energy converter and/or of the pressurized gas storage unit. By way of example, to manufacture the pressurized gas storage unit, it is possible to use conventional, commercially available storage containers that are fitted with cooling fins and/or other cooling structures on the outside. The storage containers fitted with cooling fins and/or other cooling structures may then be surrounded with a thermally insulating material layer, for example by being arranged in a bag made of plastic film. The phase change storage medium is then filled in fluid form into the interspace between the thermally insulating material layer, the cooling fins and the outside. The arrangement thereby formed may then further be surrounded by an additional thermally insulating material on the outside.

According to one advantageous embodiment of the invention, provision is made for the compression heat stored in the phase change storage medium to be able to be supplied back to the pressurized gas during the expansion of the pressurized gas and/or during the withdrawal from the pressurized gas storage unit. This has the advantage of providing a reversible process in which the stored compression heat is able to be reused in order to compensate for the temperature drop that occurs during the decompression of the pressurized gas.

According to one advantageous embodiment of the invention, provision is made for the energy storage system to be designed without a heat exchanger in the region of the second energy converter. This enables a simple and inexpensive design of the energy storage system. Such a heat exchanger may be dispensed with because the phase change storage medium is able to provide sufficient storage capacity for the compression heat.

According to one advantageous embodiment of the invention, provision is made for the first energy converter to be designed as a bidirectional energy converter by way of which either supplied electrical energy is able to be converted into hydraulic energy or hydraulic energy is able to be converted into electrical energy to be withdrawn from the energy storage system. This has the advantage that no further first energy converter is necessary for the withdrawal process. The energy storage system may thereby be designed in a relatively compact and inexpensive manner.

According to one advantageous embodiment of the invention, provision is made for the second energy converter to be designed as a bidirectional energy converter by way of which either supplied hydraulic energy is able to be converted into gas pressure energy or gas pressure energy to be withdrawn from the pressurized gas storage unit is able to be converted into hydraulic energy. This has the advantage that no further second energy converter is necessary for the withdrawal process. The energy storage system may thereby be designed in a relatively compact and inexpensive manner.

According to one advantageous embodiment of the invention, provision is made for the second energy converter to be connected to a hydraulic system, which has a tank in which a supply of hydraulic medium is stored. Such a tank means that a sufficient amount of hydraulic medium is always available when electrical energy is to be injected or withdrawn. The tank makes it possible for example to compensate for the volumetric losses of the hydraulic motor and all other leakage currents.

According to one advantageous embodiment of the invention, provision is made for the tank to be hydraulically coupled to the second energy converter via a hydraulic pump and a filter. This makes it possible to ensure that clean hydraulic medium is always supplied to the second energy converter. It is thereby possible to achieve a long service life of the energy storage system.

If using for example a tank with PCM on the outer wall, a booster pump and a filter system, the system overall has no oil losses and the oil is cleaned automatically during operation. This results in lower maintenance intensity and/or an increased service life of the components.

According to one advantageous embodiment of the invention, provision is made for a phase change storage medium to be arranged around the tank and/or in the region of the first energy converter. Unnecessary efficiency losses may thereby be avoided. The phase change storage medium means that the hydraulic medium is always able to be kept at an optimum working temperature.

According to one advantageous embodiment of the invention, provision is made for the second energy converter to be designed as a single-stroke system in which the maximum injection capacity is limited by the available capacity of the second energy converter for the hydraulic medium. This makes it possible to achieve a particularly simple and inexpensive design of the energy storage system, with the energy storage system being particularly suitable for implementing a power concept, that is to say energy may be injected at high power and also energy may be withdrawn at high power.

According to one advantageous embodiment of the invention, provision is made for the second energy converter to be designed as a cyclically operated alternating-stroke system in which, at least when electrical energy is injected into the energy storage system, the hydraulic medium is conveyed cyclically back and forth between a first and a second piston accumulator of the second energy converter. This has the advantage that very large amounts of energy are able to be stored. Less hydraulic and pneumatic cylinder volume, less hydraulic medium and less tank volume is also required. Such an energy storage system is particularly suitable for implementing a high-capacity energy storage system.

According to one advantageous embodiment of the invention, provision is made for several or all components of the energy storage system to be accommodated in a housing that corresponds to a freight container according to ISO 668, in particular a 20-foot or 40-foot freight container. This has the advantage that the energy storage system is provided in a manner able to be handled easily by the user. It is thus in particular easily possible to transport the energy storage system to the usage location or to changing usage locations, because it is possible to use available transport capacities of conventional utility vehicles. A further advantage is that a commercially available freight container is able to be used as housing, meaning that inexpensive and robust housings are available to implement the energy storage system.

According to one advantageous embodiment of the invention, the first energy converter has a hydraulic motor with an adjustable cylinder capacity. This has the advantage that, in the case of the first energy converter, it is possible to achieve particularly advantageous speed regulation and/or power regulation by adjusting the cylinder capacity of the hydraulic motor.

An advantageous method for injecting and withdrawing electrical energy by way of an energy storage system of the abovementioned type, for example an energy storage system having features a), b), c) and d), comprises the following method steps:
injecting electrical energy into the energy storage system by converting the electrical energy into hydraulic energy via the first energy converter and the hydraulic energy into gas pressure energy via the second energy converter and storing the gas pressure energy in the pressurized gas storage unit in the form of compressed pressurized gas,
withdrawing electrical energy from the energy storage system by decompressing compressed pressurized gas stored in the pressurized gas storage unit and generating hydraulic energy therefrom via the second energy converter or a further second energy converter, and converting the hydraulic energy into electrical energy via the first energy converter or a further first energy converter and outputting the electrical energy to the electrical energy supply grid or another electrical consumer.

This also makes it possible to achieve the advantages set out above.

In this case, the following may be present as an additional method step: Keeping the electrical energy in the energy storage system by keeping the pressure level within the pressurized gas storage unit and at least partially also in melting energy within the phase change storage material and at least partially also in the form of material-bound, sensitive thermal energy.

The method may have one, several or all of the following method steps k), l) and m):
thermal energy in the form of industrial waste heat and/or heat from solar panels is supplied to the energy storage system as further energy carrier, wherein the pressurized gas located in the pressurized gas storage unit is heated in the energy storage system by the thermal energy,
the pressurized gas circuit of the second energy converter is able to be connected to the ambient atmosphere via at least one valve, wherein, when electrical energy is withdrawn from the energy storage system, the valve is cyclically opened and closed, wherein the valve is closed in a respective cycle before a specific pressure value of the gas pressure in the pressurized gas circuit of the second energy converter that is above atmospheric pressure is reached,
the pressurized gas storage unit is able to be connected to the pressurized gas circuit of the second energy converter via at least one valve, wherein the pressurized gas line is cyclically opened or closed by way of at least one non-return valve and/or directional valve, wherein the non-return valve and/or directional valve is opened or closed in a respective cycle before a specific pressure value of the gas pressure in the pressurized gas circuit of the second energy converter that is above atmospheric pressure is reached,
the first energy converter has a hydraulic motor with an adjustable cylinder capacity, wherein speed regulation and/or power regulation of the hydraulic motor is carried out by adjusting the cylinder capacity of the hydraulic motor.

According to feature k), a further energy carrier may thus be used to optimize the efficiency of the energy storage system. The outlay required for this is relatively low, since a corresponding heat exchanger for receiving the thermal energy is required in the energy storage system only at an appropriate location, for example in the pressurized gas storage unit.

According to feature l), the efficiency of the energy storage system may be optimized through innovative control of the at least one valve during the withdrawal. This avoids unnecessary pressure losses in the pressurized gas circuit. The valve may thus for example be opened at the start of a respective cycle and closed again even before the end of the cycle. It may for example be checked, as closure condition, whether the product of pressure and volume in the pneumatic cylinder reaches a specific value. The value is governed by the nominal volume of the pneumatic cylinder and the minimum required differential pressure of the hydraulic motor, for example 40 bar. The at least one valve accordingly closes exactly such that the minimum pressure for the hydraulic motor is present at the end of the cycle when the pneumatic piston has reached its end point. Because the pneumatic cylinder is connected to the atmosphere again in the next cycle, only this minimum pressure is also lost, or a smaller air mass is lost in comparison with the subsequent switch. If provision is additionally made for a two-stage process for the withdrawal, the end pressure or the remaining air mass may be relaxed via a compressed air turbine and is not lost. This valve circuit means that it is possible to set exactly the maximum pressure of a commercially available compressed air turbine.

According to feature n), it is possible to achieve particularly efficient and low-loss speed regulation of the hydraulic motor, which likewise benefits the operating efficiency of the energy storage system.

The energy storage system may have a control unit, for example a control unit controlled by a computer, by way of which the individual components are controlled. The control unit may in particular also be used to control the required valves in the pressurized gas circuit and/or in the hydraulic circuit.

The object mentioned at the outset is also achieved by a computer program comprising program code means, configured to perform a method of the type set out above when the computer program is executed on a computer of a control unit of the energy storage system. The computer program makes it possible to perform at least the control functions for controlling the energy storage system so as to perform the method steps explained above.

The computer program additionally makes it possible to perform one, several or all of the following functions:
a) digital or analog measurements, storing and processing at least one of the following parameters: temperature, pressure, volumetric flow and mass flow within the electrical energy storage system,
b) controlling the valves so as to perform a multi-stage compression and expansion process within the electrical energy storage system,
c) regulating the speed and/or setting the cylinder capacity of the hydraulic motor of the first energy converter so as to optimize energy efficiency and durable operation during loading and/or during unloading of the electrical energy storage system,
d) carrying out operational monitoring and maintenance on the electrical energy storage system, with at least some of this being able to take place with the addition of machine learning for the purpose of being able to predict at least one fault case and/or usage failure,
e) providing a digital communication channel or an interface for incorporating the electrical energy storage system into a virtual power plant and/or into a group of energy storage units in accordance with a swarm concept,
f) automatically creating and issuing invoices for operators and/or users of the electrical energy storage system, at least based on energy parameters or customer or operator data as part of an energy storage as a service business model able to be applied using the energy storage system.

In summary, the following advantages may be achieved by the invention:
1. Use of PCM and cooling structures on the outer wall of the gas bottles of the pressurized gas storage unit, the piston cylinders and/or the tank
Replaces any heat exchangers in the pressurized gas storage unit, improves efficiency and reduces costs for recovering heat
2. Option to use industrial waste heat and/or heat from solar panels by way of water circuits arranged on the outer wall of the gas bottles
Uses waste heat for energy withdrawal and compensates for self-discharging of the energy storage unit, increased profitability of the system
3. Combination of hydraulic cylinder and pneumatic cylinder for the hydraulic/gas pressure transfer
Increased safety, lower maintenance intensity, longer service life, higher efficiency, achievable pressure ratio
4. Applying an insulating layer (solid temperature-resistant plastic) to the bottom of the piston prevents gas/oil heat transfer
Increases efficiency
5. In the regulation concept, adjusting the cylinder capacity of the hydraulic motor makes it possible to implement the speed regulation and/or the power regulation, which ensures that the hydraulic motor and the generator are always run at the optimum operating point.
Reduces reaction time (time to reach rated power) and increases efficiency

Where the term “pneumatic” is used, this does not refer only to air as the gas that is used, but rather encompasses gases of any kind. When the term pneumatic cylinder is used, this also includes piston cylinders that contain a non-combustible fluid in a piston chamber.

### BRIEF DESCRIPTION OF THE DRAWINGS

The invention is explained in more detail below with reference to exemplary embodiments using drawings.

In the figures

FIG. 1 shows a first embodiment of an energy storage system,

FIG. 2 shows a first embodiment of a second energy converter,

FIG. 3 shows a tank,

FIG. 4 shows a second embodiment of an energy storage system,

FIG. 5 shows a second embodiment of a second energy converter,

FIG. 6 shows a first embodiment of a pressurized gas storage unit,

FIG. 7 shows a second embodiment of a pressurized gas storage unit,

FIG. 8 shows a third embodiment of an energy storage system,

FIG. 9 shows a third embodiment of a second energy converter.

### DETAILED DESCRIPTION OF THE INVENTION

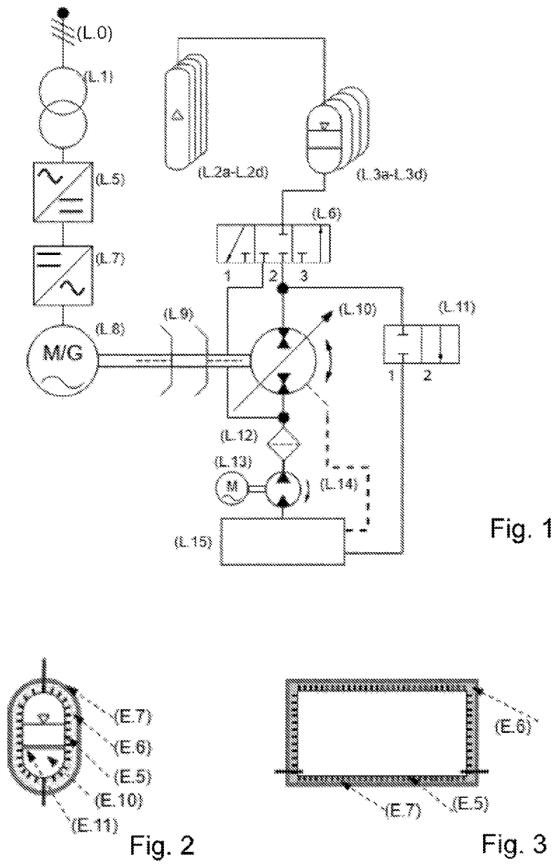

The energy storage system illustrated in FIG. 1 is designed as a closed system. The energy storage system has an electrical connection unit for connecting the energy storage system to an electrical energy supply grid L.0, for example to a three-phase grid. The electrical connection unit has a transformer L.1 and a frequency converter L.5, L.7. The frequency converter L.5, L.7 is connected to an electric machine L.8, which is connected to an adjustable axial piston machine L.10 via a clutch L.9. The electric machine L.8 and the axial piston machine L.10 form, together with the clutch L.9, a first energy converter of the energy storage system.

The axial piston machine L.10 is hydraulically connected to a hydraulic circuit in which a first valve L.6, a second valve L.11, a tank L.15, a booster pump L.14, which is able to be driven via a motor L.13, and a filter L.12 are arranged. A hydraulic medium, for example oil, may be used in the hydraulic circuit. The first valve L.6 may be designed as a 3/3-directional valve, and the second valve L.11 may be designed as a 2/2-directional valve. The first valve may also be designed differently, for example as a combination of multiple 3/2-directional valves or 2/2-directional valves. The first valve L.6 is connected to one or more piston accumulators L.3a-L.3d that are connected in parallel. The piston accumulators L.3a-L.3d form a second energy converter for the hydraulic medium/pressurized gas energy conversion. The piston accumulators L.3a-L.3d are connected to a pressurized gas storage unit L.2a-L.2d via pressurized gas lines. The pressurized gas storage unit L.2a-L.2d may have multiple storage containers, for example gas bottles, that are connected in parallel.

When injecting energy, excess electrical energy may be used by the transformer L.1 and the frequency converter L.5, L.7 to drive the electric machine L.8, which is connected to the adjustable axial piston machine L.10 via the clutch L.9. This converts the mechanical power into hydraulic power and pumps the working fluid, for example hydraulic oil, out of the tank L.15, via the 3/3-directional valve L.6 in position 3, into one or more parallel-connected piston accumulators L.3a-3d. The booster pump L.14 with the associated electric motor L.13 ensures an inlet pressure at the input of the axial piston machine L.10 even in the event of pressure loss of the filter L.12. The pumping work of the axial piston machine L.10 leads, in the piston accumulators L.3a-3d, to an “upward” displacement of the piston, that is to say to a reduction in the gas volume, in response to which the gas in the gas bottles L.2a-2d is compressed and its pressure is increased. During the withdrawal, the 3/3-directional valve L.6 is put into position 1, so as to achieve the same direction of rotation of the axial piston machine L.10 during withdrawal and injection. The axial piston machine L.10 relaxes the oil, which is under the gas pressure, and in the process drives the electric machine L.8. The oil is fed back into the tank L.15 via the shut-off valve L.11 in position 2. Pure nitrogen may be used as gas.

FIG. 2 shows the piston accumulator L3a-3d modified according to the invention. A cooling fin frame E.5 made of aluminum (alternatively copper, ceramics) is fastened around a commercially available piston accumulator E.10. This increases the heat transfer surface with the phase change storage material E.6 (PCM, phase change material) and thus the heat exchange dynamics, which leads to a lower temperature rise on the gas side of the piston accumulator. The cooling fin frame E.5 is surrounded by a thin plastic layer and the PCM is inserted into the remaining cavities. Thermal insulation E.7, for example made of foam or polystyrene and for example a few centimeters thick, is produced around the plastic layer. The bottom of the piston is additionally provided with a thermal insulation layer E.11, for example solid plastic, in order to minimize the transfer of heat from oil to the gas.

The effect of the PCM: The compression heat flows via the cylinder outer wall to the cooling fins and to the PCM and first brings about a temperature increase of these components and the gas, up to the melting point of the PCM. Compression heat that accrues beyond this leads to liquefaction of the PCM and no longer directly to a temperature increase of the components (the temperature increase actually levels off depending on the heat exchange dynamics (heat transfer surface)).

FIG. 3 shows a modified tank, for example the tank L.15. Similarly to the piston accumulator L3a-3d, a cooling fin frame E.5 made of aluminum (alternatively copper, ceramics) may be attached around the tank. The cooling fin frame E.5 is surrounded by a thin plastic layer and the PCM is inserted into the remaining cavities. Thermal insulation E.7, for example made of foam or polystyrene and for example a few centimeters thick, is produced around the plastic layer. The PCM E.6 with the cooling fins E.5 and the insulation E.7 around the tank always keeps the oil at the optimum working temperature, since the optimum working temperature of the oil (46-52° C.) matches the melting temperature of the PCM relatively precisely.

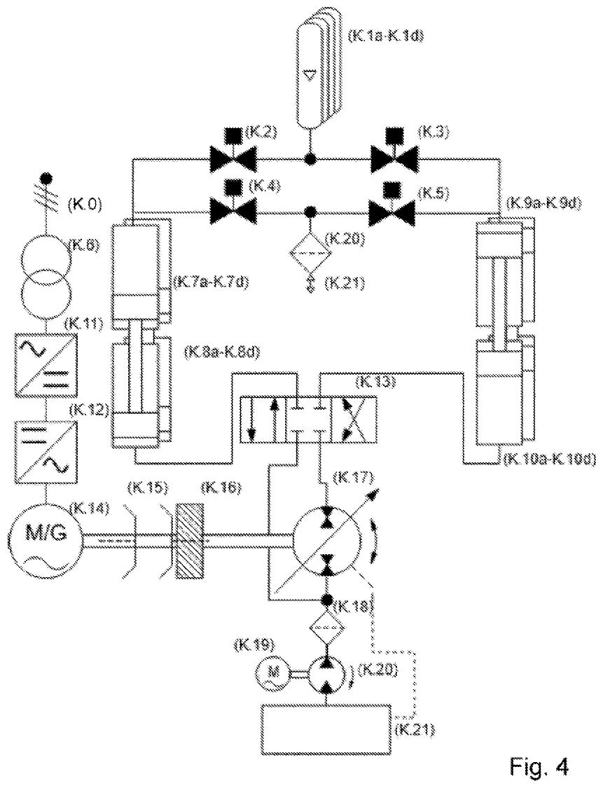

The energy storage system according to FIG. 1 may be used for example to implement a power concept. FIG. 4 shows one embodiment of an energy storage system that is well-suited as a capacity concept. The energy storage system according to FIG. 4 is designed as an open system that is connected to the atmosphere when required. An electrical energy supply grid K.0 is connected to the first energy converter K.14, K.15, K.16, K.17 via an electrical connection unit K.6, K.11, K.12. The electrical connection unit may, in a manner comparable to the embodiment of FIG. 1, have a transformer K.6 and a frequency converter K.11, K.12. The first energy converter may, in a manner comparable to the embodiment of FIG. 1, have an electric machine K.14 and an axial piston pump K.17 as conveyor device for the hydraulic medium. The electric machine K.14 is connected to this axial piston machine K.17 via a clutch K.15 and a flywheel mass K.16 that is coupled to the shaft of the axial piston machine K.17.

The axial piston machine K.17 is connected to a hydraulic circuit. The hydraulic circuit, similarly to the embodiment of FIG. 1, has a tank K.21, a booster pump K.22 with an electric motor K.19, and a filter K.18. A first valve K.13, which in this case is designed as a 4/3-directional valve, is also present here for controlling the hydraulic medium. Of course, the first valve K.13 may also be formed by another arrangement of directional valves.

The first valve K.13 is used to connect the explained hydraulic circuit, in particular the axial piston machine K.17, to a first hydraulic cylinder group K.8a-K.8d and a second hydraulic cylinder group K.10a-K.10d. The respective hydraulic cylinders of the two hydraulic cylinder groups K.8a-K.8d, K.10a-K.10d are mechanically coupled to respective pneumatic cylinders K.7a-K.7d, K.9a-K.9d via their piston rods. These arrangements of the hydraulic cylinders and the pneumatic cylinders form the second energy converter. Controlling the first valve K.13 appropriately allows the axial piston machine K.17 to pump the hydraulic medium either from the first hydraulic cylinder group K.8a-K.8d into the second hydraulic cylinder group K.10aK.10d or in the opposite direction, that is to say from the second hydraulic cylinder group K.10a-K.10d into the first hydraulic cylinder group K.8a-K.8d.

The pressurized gas connections of the pneumatic cylinders K.7a-K.7d, K.9a-K.9d are able to be selectively connected, via control shut-off valves K.2, K.3, to the pressurized gas storage unit, which, in this case, similarly to the embodiment of FIG. 1, is formed by multiple gas bottles K.1a-K.1d that are connected in parallel. The pressurized gas connections of the pneumatic cylinders are additionally able to be selectively connected, via the control shut-off valves K.4, K.5, to an atmospheric connection K.21 via an air filter K.20. The atmospheric connection K.21 is connected to the ambient atmosphere.

In the same way as in the power concept, during energy injection, excess electrical energy may be used to drive the electric machine K.14, which is coupled to the axial piston machine K.17. This converts mechanical power into hydraulic power and pumps the working fluid (for example hydraulic oil) from one or more parallel-connected hydraulic cylinders K.8a8d into the second group of one or more parallel-connected hydraulic cylinders K.10a-10d. Each hydraulic cylinder is connected fixedly to a pneumatic cylinder K.7a-7d, K.9a-9d.

As a result of pumping the working fluid out of the initially full hydraulic cylinder, external air is drawn into the pneumatic cylinder connected thereto via the atmospheric connection K.21. The gas bottles are connected to the other pneumatic cylinder group, which are coupled to the hydraulic cylinders to be filled. The pneumatic cylinders on this side, through the pumping work of the axial piston machine K.17, compress the gas in the pressurized gas bottles K.1a-K.1d. If the hydraulic cylinders on this side are full, the valve control of the control shut-off valves K.2-K.5 makes it possible to connect the pressurized gas bottles K.1a-K.1d to the pneumatic cylinders of the other unit, and the second cycle starts over.

The energy storage unit is fully loaded when the pressure in the pressurized gas bottles K.1a-1d reaches a specific maximum pressure (up to 350 or 500 bar). The higher the withdrawal time of the required application, the more pressurized gas bottles are used and the more cycles are run through. During the withdrawal, the pressurized gas bottles are always connected to the side with the full hydraulic cylinders and accordingly empty pneumatic cylinders, such that the operating mode is able to be reversed and the axial piston machine K.17 is able to use the differential pressure of the pressurized gas bottles with respect to atmospheric pressure to drive the electric machine K.14.

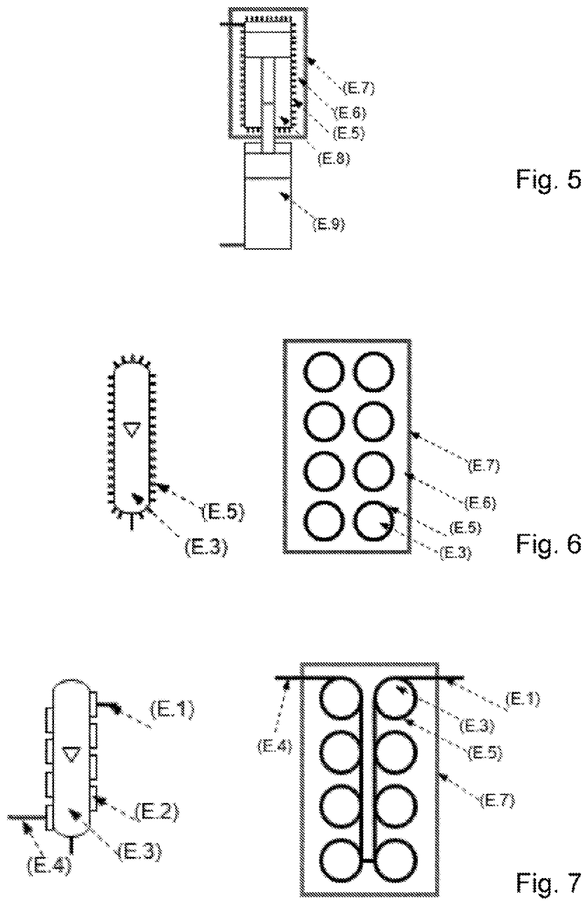

FIG. 5 shows one of the hydraulic cylinder/pneumatic cylinder arrangements from FIG. 4 by way of example. Similarly to the piston accumulator, the single-action pneumatic cylinder E.8 is provided with cooling fins E.5, PCM E.6 and thermal insulation E.7, and the single-action hydraulic cylinder E.9 is not.

The gas bottles form, together with the PCM that is used and the thermal insulation, the pressurized gas storage unit able to be used uniformly for both concepts. FIG. 6 shows the simplified sectional view of a gas bottle from the side and of a set of gas bottles from above.

The gas bottles E.3, for example having a volume of in each case 50 to 400 l, are procured in the required quantity, provided with the cooling structures E.5 and placed in a frame, for example made of steel and/or aluminum, in which multiple gas bottles are able to be accommodated. In conventional set frames, the space between the gas bottles is not sufficient to accommodate cooling fins and the required amount of PCM therein. The number of sets of gas bottles is determined depending on the capacity requirements of the customer. After the gas bottles with cooling fins have been placed in the frame, the PCM E.6 is inserted into the cavities. At the same time, the frame is heated so that the PCM melts and the cavities are fully utilized. Thermal insulation E.7 made for example of foam or polystyrene, of a few centimeters, is then produced around the frame.

Industrial waste heat may be used by the pressurized gas storage unit illustrated in FIG. 7, both with the power concept and with the capacity concept. FIG. 7 shows the simplified sectional view of a gas bottle from the side and of a set of gas bottles from above. Instead of the cooling fins, the gas bottles E.3 are wound around by a rectangular water line E.2 with good thermal conductivity, the ends of which are connected to a feed line connection E.1 and a return line connection E.4 of the frame. As an alternative, the heat-carrying water may surround the gas bottles directly and be diverted and replaced with new heat-carrying water when a specific temperature is fallen below.

In this case too, the frame is then surrounded with insulating material E.7. The warm water from industrial waste heat flows into the feed line, around the gas bottles, heats them, thereby increases the gas pressure therein and flows back out of the return line in colder form.

Depending on customer requirements, the pressurized gas storage unit of the overall energy storage system may consist of one or more units according to FIG. 6, of one or more units according to FIG. 7 or a mixture of units according to FIGS. 6 and 7 that may be accommodated, jointly or separately, in containers.

The container of the pressurized gas storage unit may be internally insulated and be provided with a pressurized gas connection for the connection to the container in which the power unit of the energy storage system is accommodated. Depending on how industrial waste heat is used, the feed and return line connection should of course also be provided on the container, in the case of which the individual feed and return line connections of the waste heat capacity units are connected together.

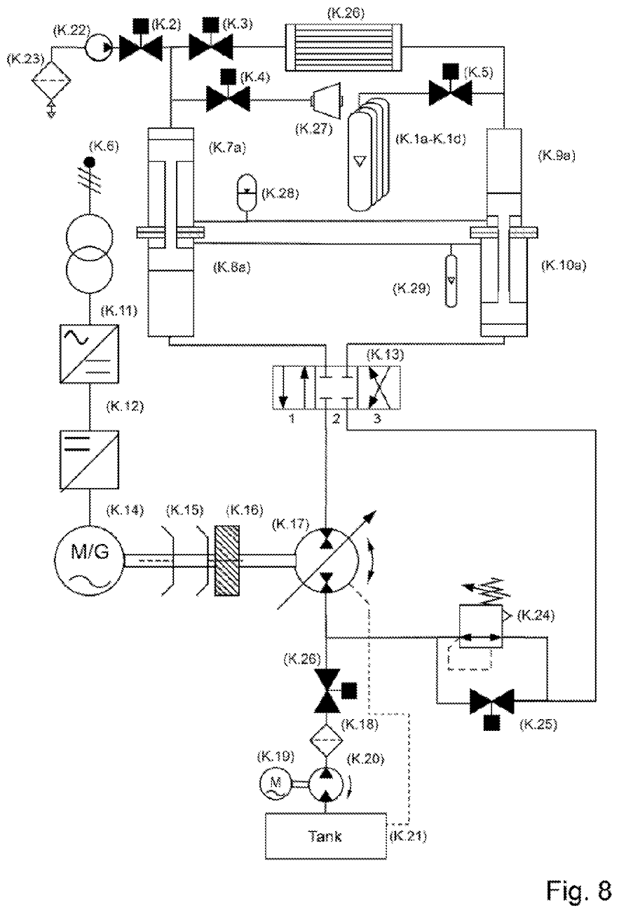

FIG. 8 shows a third embodiment of an energy storage system that, similarly to the embodiment of FIG. 4, is designed as an open system. To increase efficiency when injecting pressurized gas from the atmosphere or when withdrawing pressurized gas from the pressurized gas circuit into the atmosphere, a compression machine K.22 is arranged downstream of the air filter K.23 on the intake side. By virtue of the compression machine K.22, the air taken in from the atmosphere is fed into the pressurized gas circuit in already pre-compressed form. It is thereby possible to achieve a multi-stage process when injecting electrical energy into the energy storage system. The compression machine K.22 may be connected to the pneumatic cylinder K.7a via the valve K.2. Switching the valve K.3 additionally makes it possible to establish a connection to the pneumatic cylinder K.9a. The valve K.5 may furthermore be used to establish a connection to the pressurized gas storage unit K.1a-K.1d.

In the same way, pressurized gas may be output from the pressurized gas circuit into the atmosphere in a two-stage process. To this end, an expansion machine K.27 is present and is able to be connected to the pressurized gas circuit via a valve K.4. By virtue of the expansion machine K.27, additional energy is able to be recovered when the pressurized gas is let out into the atmosphere.

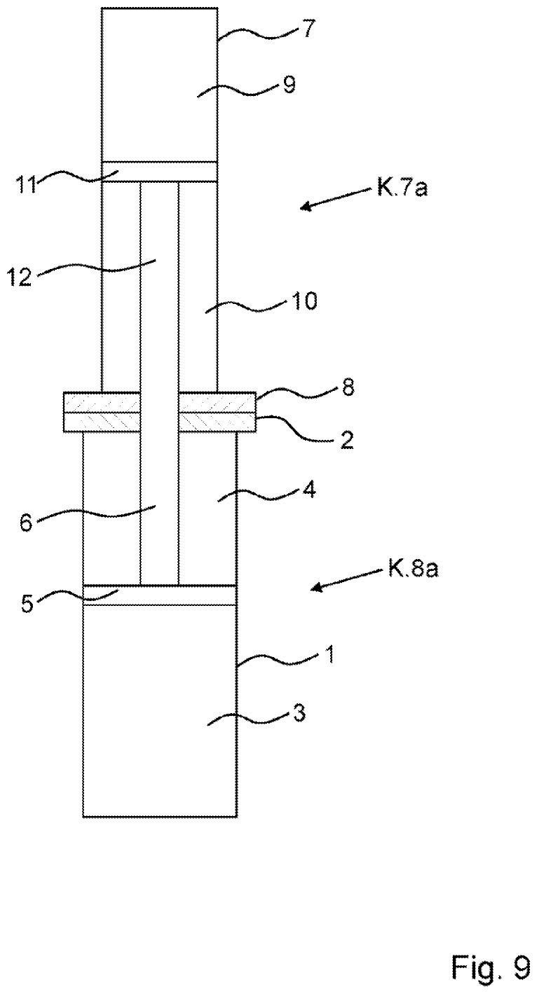

In the embodiment of FIG. 8, similarly to FIG. 4, a design of the second energy converter in the form of respective hydraulic cylinders, which are mechanically coupled to a pneumatic cylinder respectively associated therewith, is implemented. FIG. 8 proposes an embodiment of these coupled cylinders such that these are mechanically coupled directly by way of their housings, for example by being flanged to one another. The further details of such an embodiment are discussed below with reference to FIG. 9. The cylinders K.7a, K.8a and/or the cylinders K.9a, K.10a may be designed according to the embodiment of FIG. 9, or in another way, as described for example with reference to the exemplary embodiments explained above.

The respective piston chambers of the hydraulic cylinders K.8a, K.10a that are not to be filled with hydraulic medium are connected to a storage reservoir K.29. An inert gas is stored in the storage reservoir K.29. The respective piston chambers of the pneumatic cylinders K.7a, K.9a that are not to be filled with pressurized gas are connected to a storage reservoir K.28. A non-combustible fluid is stored in the storage reservoir K.28.

In the same way as in the power concept, during energy injection, excess electrical energy may be used to drive the electric machine K.14, which is coupled to the axial piston machine K.17. This converts mechanical power into hydraulic power and pumps the working fluid (for example hydraulic oil) from at least one parallel-connected hydraulic cylinder K.8a into the second group of a parallel-connected hydraulic cylinder K.10a. Each hydraulic cylinder is connected fixedly to a pneumatic cylinder K.7a, K.9a.

A loading cycle begins with the pneumatic cylinder K.7a filled with pressurized gas to the inlet pressure of the compressor K.22. The hydraulic power is used in the first partial cycle to press the pressurized gas into the parallel-connected pneumatic cylinder K.9a. In this process, heat may be extracted from the pressurized gas with the aid of the heat exchanger K.26. The working fluid is pressed out of the piston K.10a and pumped into the hydraulic cylinder K.8a via the axial piston machine. The gas volume of the pneumatic cylinder K.9a is less than the gas volume of the pneumatic cylinder K.7a, which is why there is a gas compression. In the next partial cycle, the compressor K.22 fills the pneumatic cylinder K.7a with pressurized gas, and in the process the working fluid is pressed out of the hydraulic piston. The axial piston machine conveys the working fluid into the hydraulic cylinder K.10a, and in the process the pressurized gas in the pneumatic cylinder K.9a is compressed and pressed into the gas bottles K.1a-1d. The first loading cycle finishes following these processes and another loading cycle may begin.

The energy storage unit is fully loaded when the pressure in the pressurized gas bottles K.1a-1d reaches a specific maximum pressure (up to 350 or 500 bar). The higher the injection time of the required application, the more pressurized gas bottles are used and the more cycles are run through.

An unloading cycle begins with the pneumatic cylinder K.9a with minimum gas volume and the hydraulic cylinder K.10a fixedly connected thereto, which is completely filled with the hydraulic fluid. The pneumatic cylinder K.7a has a maximum pressurized gas volume. The first partial cycle begins with the gas bottles K.1a-1d being connected to the pneumatic cylinder K.9a. The end pressure of the pneumatic cylinder K.9a may be set by the valve K.5. As a result of the applied gas pressure, the working fluid is pressed out of the hydraulic cylinder K.10a and relaxed via the hydraulic motor K.17 and conveyed into the hydraulic cylinder K.8a. The pressurized gas in K.7a is in the process relaxed via the turbine K.27a. The second partial cycle begins with the pneumatic cylinder K.9a being connected to the pneumatic cylinder K.7a by the valve K.3. In this process, heat may be supplied to the pressurized gas with the aid of the heat exchanger K.26. The differently sized piston surfaces of the cylinders K.7a and K.8a and of the cylinders K.9a and K.10a creates a pressure ratio that leads to a pressure difference and accordingly to a mechanical power at the hydraulic motor K.17. By virtue of the electric machine K.14, the mechanical power is converted into electric power and made available again to the connection point via the components K.12 and K.11.

FIG. 9 illustrates one advantageous embodiment of a second energy converter in the form of directly mechanically coupled cylinders K.7a, K.8a. The hydraulic cylinder K.8a has a housing 1 in which a piston 5 is mounted so as to be able to move longitudinally. The piston 5 divides the inside of the housing 1 into a first piston chamber 3 and a second piston chamber 4. The size of the piston chambers 3, 4 is changed depending on the position of the piston 5.

The pneumatic cylinder K.7a has a housing 7 in which a piston 11 is mounted so as to be able to move longitudinally. The piston 11 divides the inside of the housing 7 into a first piston chamber 9 and a second piston chamber 10. The size of the piston chambers 9, 10 is changed depending on the position of the piston 11. Depending on whether and to what order of magnitude a pressure ratio is desirable, the effective piston surfaces of the pistons 5 and 11 may be the same or different. By way of example, the piston surface of the piston 5 may be larger or smaller than the piston surface of the piston 11.

The housings 1, 7 of the cylinders K.7a, K.8a are connected to one another via flanges 2, 8. The piston 5 is connected to the piston 11 via a continuous piston rod 6, 12. The first piston chamber 3 serves as reception chamber for the hydraulic medium, for example oil. The first piston chamber 9 of the pneumatic cylinder K.7a serves as reception chamber for the pressurized gas, for example air from the atmosphere. The second piston chamber 4 of the hydraulic cylinder K.8a is connected to the storage container K.29. More or less inert gas is injected from the storage container K.29 into the second piston chamber 4 of the hydraulic cylinder K.8a depending on the position of the piston 5. The second piston chamber 12 of the pneumatic cylinder K.7a is connected to the storage container K.28. More or less non-combustible fluid is injected from the storage container K.28 into the second piston chamber 12 of the pneumatic cylinder K.7a depending on the position of the piston 11.

1. An electrical energy storage system for injecting and withdrawing electrical energy, comprising:
a) an electrical connection unit for connecting the energy storage system to an electrical energy supply grid,
b) a first energy converter that is electrically connected to the electrical connection unit and is configured to convert electrical energy supplied via the energy supply grid into hydraulic energy that is provided via a hydraulic medium located in the energy storage system,
c) a second energy converter that is hydraulically connected to the first energy converter and is configured to convert the hydraulic energy provided by the first energy converter into gas pressure energy that is provided via a pressurized gas located in the energy storage system,
d) a pressurized gas storage unit that is connected to the second energy converter via a pressurized gas connection and is configured to store the gas pressure energy provided by the second energy converter in the form of compressed pressurized gas,
further comprising at least one of:
e) at least part of the second energy converter and/or of the pressurized gas storage unit has a phase change storage medium in which compression heat that arises when the pressurized gas is compressed is able to be stored,
f) the second energy converter has at least one piston chamber in which a separator piston is mounted so as to be moveable, wherein the pressurized gas is separated from the hydraulic medium by the separator piston, wherein the separator piston has a base material and a thermal insulation material that has lower thermal conductivity than the base material, wherein a thermal insulation layer is formed between the pressurized gas and the hydraulic medium by the thermal insulation material,
g) the second energy converter has at least one hydraulic cylinder and a pneumatic cylinder that is separate from the hydraulic cylinder and is mechanically coupled to the hydraulic cylinder.

2. The electrical energy storage system as claimed in claim 1, wherein at least part of the phase change storage medium is arranged on an outside of at least part of the second energy converter and/or of the pressurized gas storage unit, on which cooling fins and/or other cooling structures are arranged.

3. The electrical energy storage system as claimed in claim 2, wherein the cooling fins and/or other cooling structures are covered with a thermally insulating material layer and the phase change storage medium is arranged in the cavities remaining between the thermally insulating material layer, the cooling fins and/or other cooling structures and the outside of at least part of the second energy converter and/or of the pressurized gas storage unit.

4. The electrical energy storage system as claimed in claim 1, wherein the compression heat stored in the phase change storage medium is suppliable back to the pressurized gas during the expansion of the pressurized gas and/or during the withdrawal from the pressurized gas storage unit.

5. The electrical energy storage system as claimed in claim 1, wherein the energy storage system is designed without a heat exchanger in the region of the second energy converter.

6. The electrical energy storage system as claimed in claim 1, wherein the first energy converter is designed as a bidirectional energy converter by way of which either supplied electrical energy is convertable into hydraulic energy or hydraulic energy is convertable into electrical energy to be withdrawn from the energy storage system.

7. The electrical energy storage system as claimed in claim 1, wherein the second energy converter is designed as a bidirectional energy converter by way of which either supplied hydraulic energy is convertable into gas pressure energy or gas pressure energy to be withdrawn from the pressurized gas storage unit is convertable into hydraulic energy.

8. The electrical energy storage system as claimed in claim 1, wherein the second energy converter is connected to a hydraulic system, which has a tank in which a supply of hydraulic medium is stored.

9. The electrical energy storage system as claimed in claim 8, wherein the tank is hydraulically coupled to the second energy converter via a hydraulic pump and a filter.

10. The electrical energy storage system as claimed in claim 8, wherein a phase change storage medium is arranged around the tank and/or in the region of the first energy converter.

11. The electrical energy storage system as claimed in claim 1, wherein the second energy converter is designed as a single-stroke system in which a maximum injection capacity is limited by an available capacity of the second energy converter for the hydraulic medium.

12. The electrical energy storage system as claimed in claim 1, wherein the second energy converter is designed as a cyclically operated alternating-stroke system in which, at least when electrical energy is injected into the energy storage system, the hydraulic medium is conveyed cyclically back and forth between a first and at least one second piston accumulator of the second energy converter.

13. The electrical energy storage system as claimed in claim 1, wherein several or all components of the energy storage system are accommodated in a housing that corresponds to a freight container according to ISO 668.

14. A method for injecting and withdrawing electrical energy by way of an energy storage system comprising:
a) an electrical connection unit for connecting the energy storage system to an electrical energy supply grid,
b) a first energy converter that is electrically connected to the electrical connection unit and is configured to convert electrical energy supplied via the energy supply grid into hydraulic energy that is provided via a hydraulic medium located in the energy storage system,
c) a second energy converter that is hydraulically connected to the first energy converter and is configured to convert the hydraulic energy provided by the first energy converter into gas pressure energy that is provided via a pressurized gas located in the energy storage system,
d) a pressurized gas storage unit that is connected to the second energy converter via a pressurized gas connection and is configured to store the gas pressure energy provided by the second energy converter in the form of compressed pressurized gas,
the method comprising:
i) injecting electrical energy into the energy storage system by converting the electrical energy into hydraulic energy via the first energy converter and the hydraulic energy into gas pressure energy via the second energy converter and storing the gas pressure energy in the pressurized gas storage unit in the form of compressed pressurized gas,
j) withdrawing electrical energy from the energy storage system by decompressing compressed pressurized gas stored in the pressurized gas storage unit and generating hydraulic energy therefrom via the second energy converter or a further second energy converter, and converting the hydraulic energy into electrical energy via the first energy converter or a further first energy converter and outputting the electrical energy to the electrical energy supply grid or another electrical consumer,
the method further comprising at least one of:
k) supplying thermal energy in the form of industrial waste heat and/or heat from solar panels to the energy storage system as further energy carrier, wherein the pressurized gas located in the pressurized gas storage unit is heated in the energy storage system by the thermal energy,
l) wherein the pressurized gas circuit of the second energy converter is selectively connectable to the ambient atmosphere via at least one valve, and, when electrical energy is withdrawn from the energy storage system, cyclically opening and closing the at least one valve, wherein the at least one valve is closed in a respective cycle before a specific pressure value of the gas pressure in the pressurized gas circuit of the second energy converter that is above atmospheric pressure is reached,
m) wherein the pressurized gas storage unit is selectively connectable to the pressurized gas circuit of the second energy converter via at least one non-return valve and/or directional valve, and comprising cyclically opening and closing the at least one non-return valve and/or directional valve, wherein the nonreturn valve and/or directional valve is opened or closed in a respective cycle before a specific pressure value of the gas pressure in the pressurized gas circuit of the second energy converter that is above atmospheric pressure is reached,
n) the first energy converter has a hydraulic motor with an adjustable cylinder capacity, further comprising adjusting the cylinder capacity of the hydraulic motor to perform speed regulation and/or power regulation of the hydraulic motor.

15. The method as claimed in claim 14, the energy storage system comprises at least one of.
e) at least part of the second energy converter and/or of the pressurized gas storage unit has a phase change storage medium in which compression heat that arises when the pressurized gas is compressed is able to be stored,
f) the second energy converter has at least one piston chamber in which a separator piston is mounted so as to be movable, wherein the pressurized gas is separated from the hydraulic medium by the separator piston, wherein the separator piston has a base material and a thermal insulation material that has lower thermal conductivity than the base material, wherein a thermal insulation layer is formed between the pressurized gas and the hydraulic medium by the thermal insulation material,
g) the second energy converter has at least one hydraulic cylinder and a pneumatic cylinder that is separate from the hydraulic cylinder and is mechanically coupled to the hydraulic cylinder.

16. (canceled)

17. The method as claimed in claim 15, wherein at least part of the phase change storage medium is arranged on an outside of at least part of the second energy converter and/or of the pressurized gas storage unit, on which cooling fins and/or other cooling structures are arranged.

18. The method as claimed in claim 17, wherein the cooling fins and/or other cooling structures are covered with a thermally insulating material layer and the phase change storage medium is arranged in cavities remaining between the thermally insulating material layer, the cooling fins and/or other cooling structures and the outside of at least part of the second energy converter and/or of the pressurized gas storage unit.

19. The method as claimed in claim 15, wherein the compression heat stored in the phase change storage medium is suppliable back to the pressurized gas during the expansion of the pressurized gas and/or during the withdrawal from the pressurized gas storage unit.

20. The method as claimed in claim 14, wherein the energy storage system is designed without a heat exchanger in the region of the second energy converter.

21. A computer program embodied on a non-transitory computer-readable medium and comprising program code configured to perform a method as claimed in claim 14 when the computer program is executed on a computer of a control unit of the energy storage system.
